(19) United States
(12) Patent Application Publication
(10) Pub. No.: US 2023/0143958 A1
(43) Pub. Date: May 11, 2023

(54) SYSTEM FOR NEURAL ARCHITECTURE SEARCH FOR MONOCULAR DEPTH ESTIMATION AND METHOD OF USING

(71) Applicant: Woven Alpha, Inc., Tokyo (JP)

(72) Inventor: Yuki KAWANA, Tokyo-to (JP)

(21) Appl. No.: 17/944,146

(22) Filed: Sep. 13, 2022

Related U.S. Application Data
(60) Provisional application No. 63/276,527, filed on Nov. 5, 2021.

(51) Int. Cl. G06N 3/08

(52) U.S. Cl. CPC G06N 3/08

(57) ABSTRACT

An in-vehicle model training system includes a non-transitory computer readable medium for storing instructions; and a processor. The processor is configured to receive an input image; perform object detection, using an encoder, on the input image to identify at least one object, wherein the encoder includes an in-vehicle neural network (NN) model; and generate a first heatmap based on the determined distance to each identified object. The processor is configured to compare the first heatmap with a second heatmap generated by a trained neural network (NN); update the in-vehicle NN model based on differences between the first heatmap and the second heatmap; and determine whether a latency of the encoder satisfies a latency specification. The processor is configured to output the in-vehicle NN model in response to the latency satisfying the latency specification and the difference between the first heatmap and the second heatmap satisfying an accuracy specification.

### PRIORITY CLAIM AND CROSS-REFERENCE

This application claims priority to U.S. Provisional Application 63/276,527, filed Nov. 5, 2021, which is hereby incorporated by reference in its entirety.

### BACKGROUND

Neural architecture search (NAS) is a technique for automating the design of a neural network (NN) by utilizing existing NNs as a basis for designing the new NN. Methods of NAS are typically categorized into search space, search strategy, and performance estimation strategy. Each of these categories seeks to avoid deep manual training of the new NN in order to increase the speed and efficiency of designing the new NN.

Autonomous driving vehicles utilize maps and object detection in order to navigate along pathways, such as roadways or other routes. Sensors attached to the vehicle determine the location of the vehicle, such as using global positioning systems (GPS). The sensors also detect information regarding an environment surrounding the vehicle. This detected information is used by an in-vehicle system to determine a location of objects in the environment surrounding the vehicle.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a training system for training an in-vehicle neural network (NN) model, in accordance with some embodiments.

FIG. 2 is a flowchart of a method of training, deploying, and implementing an in-vehicle NN model, in accordance with some embodiments.

FIG. 3 is a schematic diagram of a system implementing an in-vehicle NN model, in accordance with some embodiments.

FIG. 4 is a schematic diagram of a system for training or implementing an in-vehicle NN model, in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In order for a vehicle to navigate autonomously, the vehicle collects information related to the environment surrounding the vehicle. This detected information is used to determine a presence and location of objects along a path of the vehicle to allow the vehicle to avoid collision with the objects. As a speed of the vehicle increases, a time for identifying objects to reduce the risk of collision is reduced. As a result, rapid processing of data from the sensor is desired by an in-vehicle system in order to rapidly identify the objects. As a speed of the vehicle increases, distance between objects and the vehicle changes more quickly which increases a desire for rapid object identification. In some embodiments, the object identification includes object location detection without object classification. In some embodiments, object identification includes both object location detection and object classification.

Despite the desire for rapid object identification, in-vehicle computation system have lower processing power that other system utilized to process information using neural networks (NN). As a result, large NN with many neurons are unlikely to be able to be processed using in-vehicle computation systems. The relatively small processing capabilities of in-vehicle computation systems is an obstacle to the desire for rapid object identification during operation of the vehicle.

This description utilizes a neural architecture search (NAS) combined with knowledge distillation (KD) in order to generate a NN model that an in-vehicle computation system is able to execute in order to identify objects, such as for autonomous driving of the vehicle. NAS is a method used to automatically search for NN architectures for a specific task, such as object identification. KD is a process of transferring knowledge from a previously trained NN model to a new NN model that is smaller, i.e., has less neurons, than the previously trained NN model. For example, in some embodiments, knowledge considered superfluous to the specific task of the smaller NN model is excluded. Using an example of a red-green-blue (RGB) image analyzed by a NN model, an in-vehicle NN model is not enhanced by the ability to accurately identify an RGB image of a pencil. This type of information is superfluous to the in-vehicle NN model. As a result, this knowledge is able to be excluded from the in-vehicle NN model. The resulting in-vehicle NN model is able to implement the specific task functionality for which the in-vehicle NN model is designed with sufficient speed to permit object identification during vehicle operation, such as during autonomous driving of the vehicle.

Using the NAS approach reduces an amount of time to develop the in-vehicle NN model in comparison with training a NN model based on raw training data, such as the Karlsruhe Institute of Technology and Toyota Technical Institute (KITTI) data set or the Dense Depth for Autonomous Driving (DDAD) data set. In addition, based on knowledge and belief of the inventors, an accuracy of the in-vehicle NN model is increased using the NAS approach in comparison with the stand alone training of a new NN model.

In some embodiments, the current description is related to depth analysis of RGB images, also called monocular depth analysis. Based on a received RGB image, the in-vehicle NN model is able to estimate a distance between identified objects and the vehicle. By utilizing RGB images, the in-vehicle NN model is capable of analyzing information related to an environment surrounding the vehicle without specialized or expensive sensors. In some embodiments, the in-vehicle NN model is able to process additional information such as point cloud data from light detection and ranging (LiDAR) sensors, acoustic sensors, or other suitable sensors.

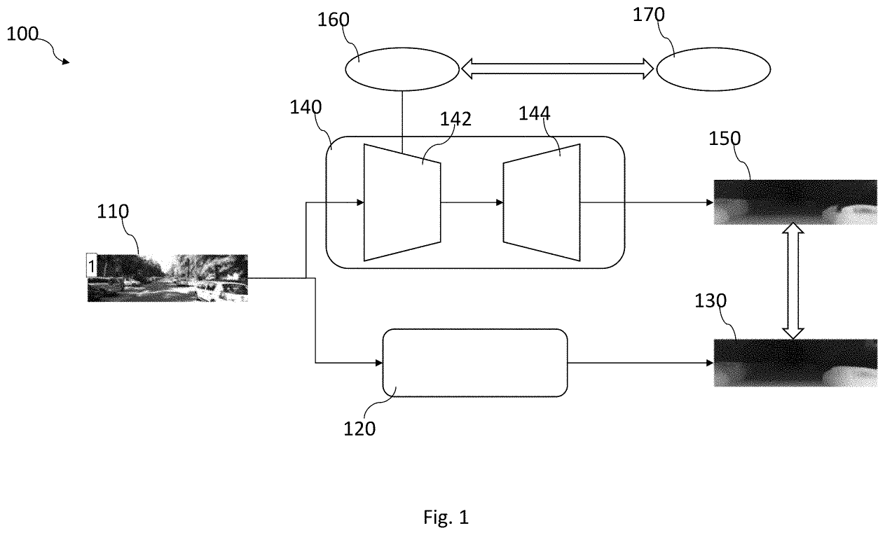

FIG. 1 is a schematic diagram of a training system 100 for training an in-vehicle neural network (NN) model, in accordance with some embodiments. The training system 100 utilizes an NAS process to find an in-vehicle NN model capable of meeting both latency and accuracy specifications. The latency specifications relate to a speed at which the in-vehicle model processes received sensor information. The accuracy specifications relate to an acceptable tolerance of error in object identification by the in-vehicle NN model. In some embodiments, at least one of the latency specifications or the accuracy specifications are input by an operator of the training system 100. In some embodiments, at least one of the latency specifications or the accuracy specifications are determined based on known processing resources of an in-vehicle computation system in which the in-vehicle NN model is planned to be deployed.

The training system 100 receives an input image 110. The input image 110 is processed by a trained NN model 120 to generate a first heat map 130 of object distance information. The trained NN model 120 was previously trained, e.g., using the KITTI data set or the DDAD data set. In some embodiments, the trained NN model 120 is considered a deep NN due to the high number of neurons in the trained NN model 120. In some embodiments, the trained NN model 120 is called a teacher model because the trained NN model 120 is used to train the in-vehicle NN model.

The training system 100 further includes an in-vehicle NN model 140. The in-vehicle NN model 140 includes an encoder 142 and a decoder 144. The encoder 142 is configured to receive the input image 110 and perform object identification. The decoder 144 is configured to receive the object identification information and determine distances between the vehicle and the identified objects. The in-vehicle NN model 140 is configured to output a second heat map 150 of object distance information.

The training system 100 further includes a latency measuring device 160 configured to determine a duration of the object identification process performed by the encoder 142. In some embodiments, the latency measuring device 160 includes a clock or time measuring component of the training system 100. The training system 100 further includes a latency database 170 configured to store latency specifications.

During operation, the training system 100 receives the input image 110. In some embodiments, the input image 110 includes an RGB image, e.g., from a camera. In some embodiments, the RGB image is a high-resolution RGB image, which includes more pixels than standard RGB images, which permits identification of more objects within the RGB image. In some embodiments, the input image 110 includes information other than an RGB image, such as a point cloud, acoustic information, or other suitable information. In some embodiments, the input image 110 is received from a database of images related to objects likely to be along pathways traveled by the vehicle. For example, in some embodiments where the vehicle is an automobile, the images include objects likely to be found along roadways, such as other automobiles, sidewalks, traffic signals, etc. In some embodiments where the vehicle is a different type of vehicle, such as a vehicle in a manufacturing plant, the images include objections likely to be found in a manufacturing plant, such as manufacturing machinery. While the description refers to roadways and uses an example of an automobile as the vehicle, one of ordinary skill in the art would understand that the vehicle of the current application is not limited to an automobile traveling on roadways.

The trained NN model 120 includes an NN model which was previously trained. The trained NN model 120 includes more neurons than the in-vehicle model 140. The trained NN model 120 receives the input image 110, analyzes the input image 110 and generates the first heat map 130 indicating a distance to teach of the objects in the input image 110. For example, the white automobile on the left side of the input image 110 is shown as a bright color, such as orange, in the first heat map 130. This indicates that the white automobile is a short distance away from the position of the sensor which captured the input image. In contrast, the horizon line of the roadway from the input image 110 is very dark, which indicates that the distance is very far from the sensor. The first heat map 130 is usable to determine distances between various objects in the input image 110 and the sensor location. One of ordinary skill in the art would understand that a distance between a sensor mounted in a vehicle and the identified object is usable to determine a distance between the vehicle, as a whole, and the identified object.

The encoder 142 also receives the same input image 110 as the trained NN model 120. The encoder 142 includes a NN used to identify objects within the input image 110. The NN of the encoder 142 has fewer neurons than the trained NN model 120. The encoder 142 outputs detected objects to the decoder 144. In some embodiments, the encoder 142 performs semantic segmentation in order to label each pixel of the input image 110 as either part of an object that presents a collision risk for the vehicle or not part of an object that presents a collision risk for the vehicle. In some embodiments, the encoder 142 is configured to identify the presence or absence of an object that presents a collision risk. In some embodiments, where the encoder 142 is more robust, the encoder 142 is configured to provide classification of some types of objects detected within the input image 110. For example, in some embodiments, the encoder 142 is configured to identify whether a detected object is an automobile, a sidewalk, a traffic signal, etc. The classification of detected objects by the encoder 142 provides more detailed information usable by an in-vehicle computation system, e.g., to implement autonomous driving. However, the classification of objects utilizes more processing capacity and increases latency in analysis of the input image 110. In some embodiments, a robustness of the encoder 142 is set based on capabilities of the in-vehicle computation system in which the in-vehicle model 140 will be deployed. Based on this robustness, whether the encoder 142 performs object classification and to what degree the encoder 142 performs object classification is determined.

The decoder 144 receives the detected objects from the encoder 142. The decoder 144 determines a distance from the sensor to the detected objects for each of the pixels having a detected object. Based on these distances, the decoder 144 generates the second heatmap 150.

The second heatmap 150 is compared with the first heatmap 130 to determine differences between the two heatmaps. Based on these differences, weights within the NN of the encoder 142 are updated. The process of receiving the input image 110, generation of the first heatmap 130 and the second heatmap 150, and comparison of the heatmaps is repeated until the similarity between the second heatmap 150 and the first heatmap 130 satisfies accuracy specifications for the in-vehicle NN model 140. The repeated iterations of the process are called training the in-vehicle NN model 140. In some embodiments, the in-vehicle NN model 140 is called the student model because the in-vehicle NN model 140 is learning from the trained NN model 120, which functions as a teacher model. Each iteration of the process is called an epoch. Each epoch is performed with a new input image 110, e.g., from an input image database. In some embodiments, the training of the in-vehicle NN model 140 is performed for a maximum number of epochs. If the in-vehicle NN model 140 fails to satisfy the accuracy specifications after a maximum number of epochs of the training, the in-vehicle NN model 140 is evaluated to determine whether the in-vehicle NN model 140 has a sufficient number of neurons or whether some other problem is preventing convergence between the in-vehicle NN model 140 and the trained NN model 120. In some embodiments, new input images 110 are input into the training system 100 to attempt to continue training of the in-vehicle model 140 in response to the training reaching the maximum number of epochs.

In addition to meeting the accuracy specifications, the encoder 142 is also designed to satisfy latency specifications. The latency measuring device 160 determines a duration for the encoder 142 to analyze the input image 110 for each epoch. This duration is called the latency for the encoder 142. The latency from the latency measuring device 160 is compared with latency specifications from the latency database 170. If the latency from the latency measuring device 160 fails to meet the latency specifications for the in-vehicle computation system in which the encoder 142 will be deployed, the training of the encoder continues. In some embodiments, the maximum number of epochs discussed above limits the continuation of training of the encoder 142.

Once the encoder 142 satisfies both the latency specifications and the accuracy specifications, the in-vehicle NN model 140 including the encoder 142 is ready to be deployed in an in-vehicle computation system. The above training process for the encoder 142 includes an NAS process where the encoder 142 is trained automatically based on the previously trained NN model 120. In some embodiments, the in-vehicle NN model 140 is updated following deployment to in-vehicle computation system. Updating criteria are discussed below, in accordance with some embodiments.

The above description focused on training of the encoder 142 using an NAS process. One of ordinary skill in the art would understand that training of the decoder 144 using an NAS process is also possible. Training of the decoder 144 would be similar to the training of the encoder 142 except that the latency of the decoder 144 would be measured. In some embodiments, the training system 100 is utilized to train the decoder 144 using an NAS process. In some embodiments, the training system 100 is utilized to train both the encoder 142 and the decoder 144 using an NAS process.

In comparison with other approaches, that do not use the NAS process, the training system 100 is able to train the in-vehicle NN model 140 having superior accuracy and superior latency.

Table 1 shows performance metrics of a NN model trained using the training system 100 in comparison with a known ResNet18 model based on the KITTI data set. The PackNet model is used as the trained model 120.

TABLE 1

| | abs_rel | sqr_rel | rmse | rmse_log | | | | latency |
|---|---|---|---|---|---|---|---|---|
| | ↓ | ↓ | ↓ | ↓ | a1 ↑ | a2 ↑ | a3 ↑ | (ms) ↓ |
| ResNet18 | 0.116 | 0.821 | 4.616 | 0.189 | 0.874 | 0.961 | 0.983 | 10.39 |
| Current | 0.112 | 0.782 | 4.524 | 0.186 | 0.879 | 0.962 | 0.983 | 4.28 |
| PackNet | 0.111 | 0.800 | 4.576 | 0.189 | 0.880 | 0.960 | 0.982 | n/a |

Table 2 shows performance metrics of a NN model trained using the training system 100 in comparison with the known ResNet18 model based on the DDAD data set. The PackNet model is used as the trained model 120.

TABLE 2

| | abs_rel | sqr_rel | rmse | rmse_log | | | | latency |
|---|---|---|---|---|---|---|---|---|
| | ↓ | ↓ | ↓ | ↓ | a1 ↑ | a2 ↑ | a3 ↑ | (ms) ↓ |
| ResNet18 | 0.202 | 6.674 | 15.310 | 0.277 | 0.763 | 0.913 | 0.960 | 19.63 |
| Current | 0.177 | 4.723 | 14.884 | 0.262 | 0.784 | 0.919 | 0.964 | 7.00 |
| PackNet | 0.173 | 7.164 | 14.363 | 0.249 | 0.835 | 0.930 | 0.964 | n/a |

The arrows in the columns indicate whether higher or lower values are superior. The first column of Table 1 and Table 2 indicates the absolute relative difference. The second column of Table 1 and Table 2 indicates the relative square error. The third column of Table 1 and Table 2 indicates the root mean square error. The fourth column of Table 1 and Table 2 indicates the log of the root mean square error. [[Question for Inventor: what do the values a1-a3 represent?]]. The eighth column of Table 1 and Table 2 indicates latency. The latency is measured based on the PackNet model, so the PackNet latency is not applicable.

The Table 1 and Table 2 provide evidence that the accuracy of the NN model trained using the training system 100 provides equal to or superior performance over the ResNet18 model in every category. Further, the latency for the NN model trained using the training system 100 is less than 50% of the latency of the ResNet18 model. This faster analysis and increased accuracy help to facilitate the training system 100 in training NN models for deployment into vehicles to implement vehicle functions, such as autonomous driving.

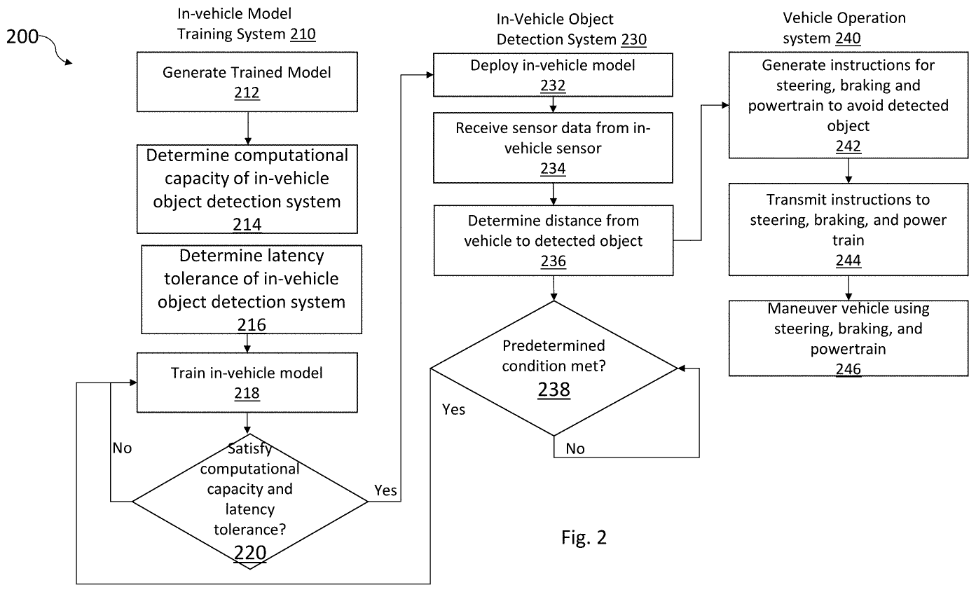

FIG. 2 is a flowchart of a method 200 of training, deploying, and implementing an in-vehicle NN model, in accordance with some embodiments. The method 200 is implemented using an in-vehicle model training system 210; an in-vehicle object detection system 230; and a vehicle operation system 240. In some embodiments, operations of the in-vehicle model training system 210 are implemented using the training system 100 (FIG. 1). In some embodiments, operations of the in-vehicle model training system 210 are implemented using a training system other than the training system 100 (FIG. 1). The in-vehicle model training system 210 implements operations 212-220. The in-vehicle object detection system 230 implements operations 232-238. The vehicle operation system 240 implements operations 242-246. The in-vehicle model training system 210 is external to a vehicle. The in-vehicle object detection system 230 and the vehicle operation system 240 are within the vehicle. In some embodiments, portions of the in-vehicle object detection system 230 and the vehicle operation system 240 are implemented using the same components within the vehicle, such as a processor, a memory, or other suitable components.

In operation 212, a trained model is generated. In some embodiments, the trained model corresponds to the trained model 120 (FIG. 1). In some embodiments, the trained model is different from the trained model 120 (FIG. 1). In some embodiments, the trained model is generated using self-supervised training. In some embodiments, the trained model is trained using the KITTI or the DDAD data set. The trained model is capable of object identification based on input sensor data. In some embodiments, the input sensor data includes RGB image data. In some embodiments, the input sensor data further includes additional sensor data, such as point cloud data, acoustic data, or other suitable input sensor data.

In operation 214 a computational capacity of the in-vehicle object detection system 230 is determined. The computational capacity indicates a processing load that the in-vehicle object detection system 230 is capable of handling. In some embodiments, the computational capacity is determined automatically based on data regarding the components of the in-vehicle object detection system 230, such as from an inventory database. In some embodiments, the computational capacity is determined based on input from a user. In some embodiments, the computational capacity is determined based on empirical data related to performance of the in-vehicle object detection system 230.

In operation 214 a latency tolerance of the in-vehicle object detection system 230 is determined. The latency tolerance indicates an amount of delay that the in-vehicle object detection system 230 and the vehicle operation system 240 are capable of tolerating while maintain a risk of collision below a threshold value. In some embodiments, the latency tolerance is determined automatically based on data regarding the components of the in-vehicle object detection system 230 and the vehicle operation system 240, such as from an inventory database. In some embodiments, the latency tolerance is determined based on input from a user. In some embodiments, the latency tolerance is determined based on empirical data related to performance of the in-vehicle object detection system 230 and the vehicle operation system 240.

In operation 218, the in-vehicle model is trained. In some embodiments, the in-vehicle model is trained using a NAS process including KD. In some embodiments, the in-vehicle model is trained using the trained model generated in operation 212. In some embodiments, the in-vehicle model is trained to satisfy the computational capacity of the in-vehicle object detection system 240 and the latency tolerance of the in-vehicle object detection system 240. In some embodiments, training of the in-vehicle model uses a smaller subset of training data in comparison to re-training of the vehicle model (not shown) which is performed between steps 220 and 232. In some embodiments, training of the in-vehicle model in operation 218 is performed for a shorter time than the re-training of the vehicle model. The use of less data or a shorter training time helps to improve the speed of the NAS process. In some embodiments, the in-vehicle model corresponds to the in-vehicle NN model 140 (FIG. 1). In some embodiments, the in-vehicle model is different from the in-vehicle model 140 (FIG. 1).

In operation 220 a determination is made regarding whether the trained in-vehicle model satisfies computational capacity and latency tolerance. In response to a determination that the trained in-vehicle model fails to satisfy either of the computational capacity or the latency tolerance, the method 200 returns to operation 218 and further modification of the in-vehicle model is performed. In some embodiments, the further modification includes intervention by the user. In response to a determination that the trained in-vehicle model satisfies the computational capacity and the latency tolerance, the method 200 proceeds to operation 232.

In operation 232, the in-vehicle model is deployed within the in-vehicle object detection system 240. The in-vehicle model is deployed by transmitting the trained in-vehicle model from the in-vehicle model training system 210 to the in-vehicle object detection system 230; and storing the trained in-vehicle model within the in-vehicle object detection system 230. In some embodiments, the trained in-vehicle model is transmitted wirelessly to the in-vehicle object detection system 230. In some embodiments, the trained in-vehicle model is transmitted via a wired connection to the in-vehicle object detection system 230. In some embodiments, the trained in-vehicle model is stored on a non-transitory computer readable medium by the in-vehicle model training system 210 and then the non-transitory computer readable medium is physically transferred to the in-vehicle object detection system 230. In some embodiments, the trained in-vehicle model is transferred from the non-transitory computer readable medium to a memory within the in-vehicle object detection system 230. In some embodiments, the non-transitory computer readable medium is installed in the in-vehicle object detection system 230. The in-vehicle model is executed using a processor within the in-vehicle object detection system 240.

In operation 234, sensor data is received from an in-vehicle sensor. In some embodiments, the sensor data incudes RGB image data from a camera. In some embodiments, the RGB image data is high resolution RGB image data. In some embodiments, the sensor data includes additional information, such as point cloud data, acoustic data, or other suitable sensor data. In some embodiments, the sensor data is received from a single in-vehicle sensor. In some embodiments, the sensor data is received from multiple in-vehicle sensors.

In some embodiments, the in-vehicle object detection system 240 is configured to receive sensor data from specific sensors based on a detected operation of the vehicle. For example, in some embodiments, the in-vehicle object detection system 240 is configured to receive sensor data from only in-vehicle sensors on a front side of the vehicle in response to the vehicle transmission being in drive. In some embodiments, the in-vehicle object detection system 240 is configured to receive sensor data from only in-vehicle sensors on a rear side of the vehicle in response to the vehicle transmission being in reverse. In some embodiments, the in-vehicle object detection system 240 is configured to receive sensor data from in-vehicle sensors on a side of the vehicle in response to a turn signal of the vehicle being activated. Reducing an amount of sensor data received by the in-vehicle object detection system 230 reduces a processing load on the in-vehicle object detection system 230.

In operation 236, a distance from the vehicle to a detected object is determined. The distance from the vehicle is determined for all detected objects. In some embodiments, the distance from the vehicle is determined using an encoder, such as encoder 142 (FIG. 1), performing semantic segmentation; and then a decoder, such as decoder 144 (FIG. 1), performing determining a distance of each pixel of the sensor data including an object to the vehicle.

In some embodiments, the in-vehicle object detection system 240 is configured to process sensor data from less than all the sensors. For example, in some embodiments, the in-vehicle object detection system 240 is configured to process sensor data from only in-vehicle sensors on a front side of the vehicle in response to the vehicle transmission being in drive. In some embodiments, the in-vehicle object detection system 240 is configured to process sensor data from only in-vehicle sensors on a rear side of the vehicle in response to the vehicle transmission being in reverse. In some embodiments, the in-vehicle object detection system 240 is configured to process sensor data from in-vehicle sensors on a side of the vehicle in response to a turn signal of the vehicle being activated. Reducing an amount of sensor data processed by the in-vehicle object detection system 230 reduces a processing load on the in-vehicle object detection system 230.

In some embodiments, the in-vehicle object detection system 230 receives sensor data from less than all of the in-vehicle sensors; and processes less than all of the received sensor data. For example, in some embodiments, the in-vehicle object detection system 230 is configured to receive sensor data from sensors on the front and sides of the vehicle while the vehicle transmission is in drive. In some embodiments, in response to a turn signal being activated, the in-vehicle object detection system 230 is configured to cease processing of sensor data from sensors on a side of the vehicle opposite the direction indicated by the activated turn signal.

Following operation 236, the method 200 proceeds to both operation 238 and operation 242.

In operation 238, a determination is made regarding whether a predetermined condition is met. The predetermined condition includes a condition for triggering updating of the in-vehicle model. In some embodiments, updating the in-vehicle model includes requesting re-training of the in-vehicle model by the in-vehicle model training system 210 or receiving a new in-vehicle model from the in-vehicle model training system 210. In some embodiments, the predetermined condition includes a lapse of a predetermined time period since the in-vehicle model was deployed in the in-vehicle object detection system 230. In some embodiments, the predetermined time period ranges from 5 hours to 5 days. In some embodiments, the predetermined condition includes a detected event in the vehicle. For example, in some embodiments, the detected event includes the vehicle transmission being in park; removal of a battery of the vehicle; detecting charging of the vehicle; or another suitable detected event. In some embodiments, the predetermined condition includes a combination of factors. For example, in some embodiments, the updating of the in-vehicle model is prevented while the vehicle is in operation. Therefore, in some embodiments, the predetermined condition is met in response to detecting the vehicle transmission being in park and the predetermined time period lapsing.

In response to a determination that the predetermined condition is met, the method 200 returns to operation 218. In some embodiments, the request for an updated or new in-vehicle model is transmitted to the in-vehicle model training system 210. In some embodiments, the request is transmitted wirelessly. In some embodiments, the request is transmitted via a wired connection. In response to a determination that the predetermined condition is not met, the method 200 repeats operation 238.

In operation 242, the distance information from operation 236 is transmitted to the vehicle operation system 240 and instructions for steering, braking and powertrain operation are generated to avoid detected objects. In some embodiments, the distance information is transmitted wirelessly. In some embodiments, the distance information is transmitted via a wired connection.

A processor determines a planned trajectory for the vehicle based on a current position of the vehicle, e.g., determined by a GPS system, a path of a roadway, e.g., determined based on a stored map within the vehicle operation system 240, and the detected objects and distance received from the in-vehicle object detection system 230. Based on the planned trajectory, the processor determines whether to adjust a speed of the vehicle using braking, the powertrain of the vehicle or both. The processor further determines an amount of steering and a direction of steering based on the planned trajectory. The processor generates instructions readable by the braking, powertrain, and steering systems of the vehicle to implement the planned trajectory.

In operation 244, the generated instructions are transmitted to the braking, powertrain, and steering systems of the vehicle. In some embodiments, the instructions are transmitted wirelessly. In some embodiments, the instructions are transmitted via a wired connection.

In operation 246, the braking, powertrain, and steering systems of the vehicle implemented the received instructions to maneuver the vehicle along the planned trajectory.

In comparison with other approaches, the use of NAS process and KD in the method 200 produce an in-vehicle model with superior accuracy and latency. As a result, the vehicle is capable of significantly reducing a risk of collision with objects along the roadway in comparison with other approaches.

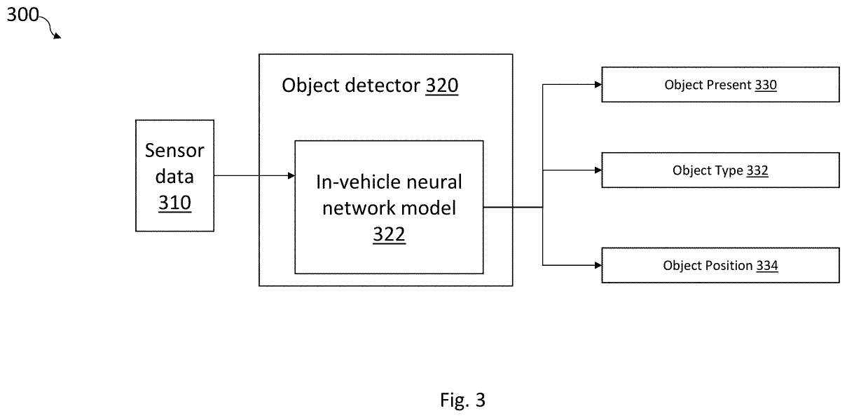

FIG. 3 is a schematic diagram of a system 300 implementing an in-vehicle NN model, in accordance with some embodiments. The system 300 receives sensor data 310. The system 300 utilizes an object detector 320 including an in-vehicle NN model 322 to output determinations regarding whether an object is present 330, an object type 332, and an object position 334. In some embodiments, the object type 322 is omitted to reduce processing load on the object detector 320.

In some embodiments, the sensor data includes the sensor data received in operation 234 (FIG. 2). In some embodiments, the object detector 320 includes a processor and a memory. The in-vehicle NN model 322 is stored on the memory and executed by the processor in order to implement object identification based on the received sensor data 310. In some embodiments, the in-vehicle NN model corresponds to the in-vehicle NN model 140 (FIG. 1). In some embodiments, the in-vehicle NN model corresponds to the trained in-vehicle model deployed in the in-vehicle object detection system 230 (FIG. 2). In some embodiments, the in-vehicle NN model is different from the in-vehicle model described with respect to FIG. 1 and FIG. 2.

In some embodiments, the object detector 320 is configured to determine the presence of an object 330 in the sensor data 310 based on semantic segmentation, e.g., using an encoder, such as encoder 142 (FIG. 1). In some embodiments, the object detector 320 is configured to determine the object type 332 in the sensor data 310 based on classification of the object using the in-vehicle NN model 322. In some embodiments, the object detector 320 is configured to determine the position of the object 334 using a decoder, e.g., decoder 144 (FIG. 1).

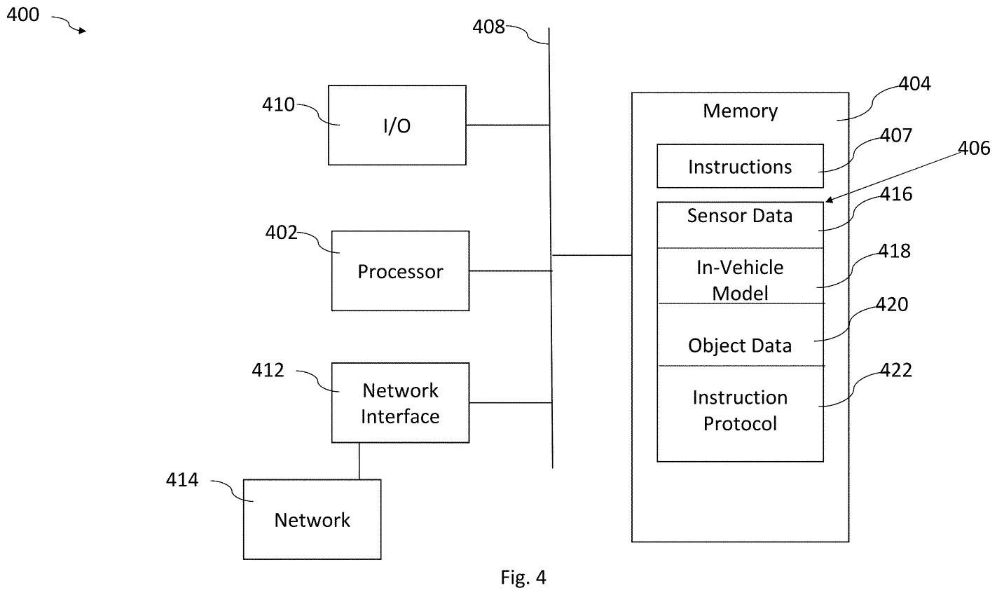

FIG. 4 is a schematic diagram of a system 400 for training or implementing an in-vehicle NN model, in accordance with some embodiments. System 400 includes a hardware processor 402 and a non-transitory, computer readable storage medium 404 encoded with, i.e., storing, the computer program code 406, i.e., a set of executable instructions. Computer readable storage medium 404 is also encoded with instructions 407 for interfacing with external devices for training or implementing an in-vehicle NN model. The processor 402 is electrically coupled to the computer readable storage medium 404 via a bus 408. The processor 402 is also electrically coupled to an I/O interface 410 by bus 408. A network interface 412 is also electrically connected to the processor 402 via bus 408. Network interface 412 is connected to a network 414, so that processor 402 and computer readable storage medium 404 are capable of connecting to external elements via network 414. The processor 402 is configured to execute the computer program code 406 encoded in the computer readable storage medium 404 in order to cause system 400 to be usable for performing a portion or all of the operations as described in training system 100 (FIG. 1), the method 200 (FIG. 2), or the system 300 (FIG. 3).

In some embodiments, the processor 402 is a central processing unit (CPU), a multi-processor, a distributed processing system, an application specific integrated circuit (ASIC), and/or a suitable processing unit.

In some embodiments, the computer readable storage medium 404 is an electronic, magnetic, optical, electromagnetic, infrared, and/or a semiconductor system (or apparatus or device). For example, the computer readable storage medium 404 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 404 includes a compact disk-read only memory (CD-ROM), a compact disk-read/write (CD-R/W), and/or a digital video disc (DVD).

In some embodiments, the storage medium 404 stores the computer program code 406 configured to cause system 400 to perform a portion or all of the operations as described in training system 100 (FIG. 1), the method 200 (FIG. 2), or the system 300 (FIG. 3). In some embodiments, the storage medium 404 also stores information needed for performing a portion or all of the operations as described in training system 100 (FIG. 1), the method 200 (FIG. 2), or the system 300 (FIG. 3) as well as information generated during performing a portion or all of the operations as described in training system 100 (FIG. 1), the method 200 (FIG. 2), or the system 300 (FIG. 3), such as a sensor data parameter 416, an in-vehicle model parameter 418, an object data parameter 420, an instruction protocol parameter 422 for interfacing with external devices and/or a set of executable instructions to perform the operation of a portion or all of the operations as described in training system 100 (FIG. 1), the method 200 (FIG. 2), or the system 300 (FIG. 3).

In some embodiments, the storage medium 404 stores instructions 407 for interfacing with external devices. The instructions 407 enable processor 402 to generate instructions readable by the external devices to effectively implement a portion or all of the operations as described in training system 100 (FIG. 1), the method 200 (FIG. 2), or the system 300 (FIG. 3).

System 500 includes I/O interface 410. I/O interface 410 is coupled to external circuitry. In some embodiments, I/O interface 410 includes a keyboard, keypad, mouse, trackball, trackpad, and/or cursor direction keys for communicating information and commands to processor 402.

System 400 also includes network interface 412 coupled to the processor 402. Network interface 412 allows system 400 to communicate with network 414, to which one or more other computer systems are connected. Network interface 412 includes wireless network interfaces such as BLUETOOTH, WIFI, WIMAX, GPRS, or WCDMA; or wired network interface such as ETHERNET, USB, or IEEE-1394. In some embodiments, a portion or all of the operations as described in training system 100 (FIG. 1), the method 200 (FIG. 2), or the system 300 (FIG. 3) is implemented in two or more systems 400, and information such as sensor data, in-vehicle mode, object data, or instructions protocols are exchanged between different systems 400 via network 414.

An aspect of this description relates to an in-vehicle model training system. The in-vehicle model training system includes a non-transitory computer readable medium configured to store instructions thereon. The in-vehicle model training system further includes a processor connected to the non-transitory computer readable medium. The processor is configured to execute the instructions for receiving an input image. The processor is configured to execute the instructions for performing object detection, using an encoder, on the received input image to identify at least one object, wherein the encoder includes an in-vehicle neural network (NN) model. The processor is configured to execute the instructions for determining a distance to each of the at least one object. The processor is configured to execute the instructions for generating a first heatmap based on the determined distance to each of the at least one object. The processor is configured to execute the instructions for comparing the first heatmap with a second heatmap generated by a trained neural network (NN). The processor is configured to execute the instructions for updating the in-vehicle NN model based on differences between the first heatmap and the second heatmap. The processor is configured to execute the instructions for determining whether a latency of the encoder satisfies a latency specification. The processor is configured to execute the instructions for outputting the in-vehicle NN model in response to the latency satisfying the latency specification and the difference between the first heatmap and the second heatmap satisfying an accuracy specification. In some embodiments, the processor is further configured to execute the instructions for performing the object detection using semantic segmentation. In some embodiments, the processor is further configured to execute the instructions for receiving the input image includes a red-green-blue (RGB) image. In some embodiments, the processor is further configured to execute the instructions for receiving the latency specification and the accuracy specification from an external device. In some embodiments, the processor is further configured to execute the instructions for performing the object detection using the in-vehicle NN model having fewer neurons than the trained NN. In some embodiments, the processor is further configured to execute the instructions for determining the distance to each of the at least one object using a decoder. In some embodiments, the processor is further configured to execute the instructions for updating the decoder based on differences between the first heatmap and the second heatmap. In some embodiments, the processor is further configured to execute the instructions for outputting the in-vehicle NN model by causing the in-vehicle model training system to wirelessly transmit the in-vehicle NN model to a vehicle.

An aspect of this description relates to an in-vehicle model training method. The method includes receiving an input image. The method further includes performing object detection, using an encoder, on the received input image to identify at least one object, wherein the encoder includes an in-vehicle neural network (NN) model. The method further includes determining a distance to each of the at least one object. The method further includes generating a first heatmap based on the determined distance to each of the at least one object. The method further includes comparing the first heatmap with a second heatmap generated by a trained neural network (NN). The method further includes updating the in-vehicle NN model based on differences between the first heatmap and the second heatmap. The method further includes determining whether a latency of the encoder satisfies a latency specification. The method further includes outputting the in-vehicle NN model in response to the latency satisfying the latency specification and the difference between the first heatmap and the second heatmap satisfying an accuracy specification. In some embodiments, performing the object detection includes using semantic segmentation. In some embodiments, receiving the input image includes receiving a red-green-blue (RGB) image. In some embodiments, the method further includes receiving the latency specification and the accuracy specification from an external device. In some embodiments, performing the object detection includes using the in-vehicle NN model having fewer neurons than the trained NN. In some embodiments, determining the distance to each of the at least one object includes using a decoder. In some embodiments, the method further includes updating the decoder based on differences between the first heatmap and the second heatmap. In some embodiments, outputting the in-vehicle NN model includes wirelessly transmitting the in-vehicle NN model to a vehicle.

An aspect of this description relates to a non-transitory computer readable medium configures to store instructions thereon. The instructions, when executed by a processor, cause the processor to receive an input image. The instructions further cause the processor to perform object detection, using an encoder, on the received input image to identify at least one object, wherein the encoder includes an in-vehicle neural network (NN) model. The instructions further cause the processor to determine a distance to each of the at least one object. The instructions further cause the processor to generate a first heatmap based on the determined distance to each of the at least one object. The instructions further cause the processor to compare the first heatmap with a second heatmap generated by a trained neural network (NN). The instructions further cause the processor to update the in-vehicle NN model based on differences between the first heatmap and the second heatmap. The instructions further cause the processor to determine whether a latency of the encoder satisfies a latency specification. The instructions further cause the processor to output the in-vehicle NN model in response to the latency satisfying the latency specification and the difference between the first heatmap and the second heatmap satisfying an accuracy specification. In some embodiments, the instructions are configured to cause the processor to receive a red-green-blue (RGB) image as the input image. In some embodiments, the instructions are configured to cause the processor to perform the object detection comprises using the in-vehicle NN model having fewer neurons than the trained NN. In some embodiments, the instructions are configured to cause the processor to cause an in-vehicle model training system to wirelessly transmit the in-vehicle NN model to a vehicle.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An in-vehicle model training system comprising:
a non-transitory computer readable medium configured to store instructions thereon; and
a processor connected to the non-transitory computer readable medium, wherein the processor is configured to execute the instructions for:
receiving an input image;
performing object detection, using an encoder, on the received input image to identify at least one object, wherein the encoder includes an in-vehicle neural network (NN) model;
determining a distance to each of the at least one object;
generating a first heatmap based on the determined distance to each of the at least one object;
comparing the first heatmap with a second heatmap generated by a trained neural network (NN);
updating the in-vehicle NN model based on differences between the first heatmap and the second heatmap;
determining whether a latency of the encoder satisfies a latency specification; and
outputting the in-vehicle NN model in response to the latency satisfying the latency specification and the difference between the first heatmap and the second heatmap satisfying an accuracy specification.

2. The in-vehicle model training system according to claim 1, wherein the processor is further configured to execute the instructions for performing the object detection using semantic segmentation.

3. The in-vehicle model training system according to claim 1, wherein the processor is further configured to execute the instructions for receiving the input image includes a red-green-blue (RGB) image.

4. The in-vehicle model training system according to claim 1, wherein the processor is further configured to execute the instructions for receiving the latency specification and the accuracy specification from an external device.

5. The in-vehicle model training system according to claim 1, wherein the processor is further configured to execute the instructions for performing the object detection using the in-vehicle NN model having fewer neurons than the trained NN.

6. The in-vehicle model training system according to claim 1, wherein the processor is further configured to execute the instructions for determining the distance to each of the at least one object using a decoder.

7. The in-vehicle model training system according to claim 6, wherein the processor is further configured to execute the instructions for updating the decoder based on differences between the first heatmap and the second heatmap.

8. The in-vehicle model training system according to claim 1, wherein the processor is further configured to execute the instructions for outputting the in-vehicle NN model by causing the in-vehicle model training system to wirelessly transmit the in-vehicle NN model to a vehicle.

9. An in-vehicle model training method comprising:
receiving an input image;
performing object detection, using an encoder, on the received input image to identify at least one object, wherein the encoder includes an in-vehicle neural network (NN) model;
determining a distance to each of the at least one object;
generating a first heatmap based on the determined distance to each of the at least one object;
comparing the first heatmap with a second heatmap generated by a trained neural network (NN);
updating the in-vehicle NN model based on differences between the first heatmap and the second heatmap;
determining whether a latency of the encoder satisfies a latency specification; and
outputting the in-vehicle NN model in response to the latency satisfying the latency specification and the difference between the first heatmap and the second heatmap satisfying an accuracy specification.

10. The in-vehicle model training method according to claim 9, wherein performing the object detection comprises using semantic segmentation.

11. The in-vehicle model training method according to claim 9, wherein receiving the input image comprises receiving a red-green-blue (RGB) image.

12. The in-vehicle model training method according to claim 9, further comprising receiving the latency specification and the accuracy specification from an external device.

13. The in-vehicle model training method according to claim 9, wherein performing the object detection comprises using the in-vehicle NN model having fewer neurons than the trained NN.

14. The in-vehicle model training method according to claim 9, wherein determining the distance to each of the at least one object comprises using a decoder.

15. The in-vehicle model training method according to claim 14, further comprising updating the decoder based on differences between the first heatmap and the second heatmap.

16. The in-vehicle model training method according to claim 9, wherein outputting the in-vehicle NN model comprises wirelessly transmitting the in-vehicle NN model to a vehicle.

17. A non-transitory computer readable medium configures to store instructions thereon that, when executed by a processor, cause the processor to:
receive an input image;
perform object detection, using an encoder, on the received input image to identify at least one object, wherein the encoder includes an in-vehicle neural network (NN) model;
determine a distance to each of the at least one object;
generate a first heatmap based on the determined distance to each of the at least one object;
compare the first heatmap with a second heatmap generated by a trained neural network (NN);
update the in-vehicle NN model based on differences between the first heatmap and the second heatmap;
determine whether a latency of the encoder satisfies a latency specification;
output the in-vehicle NN model in response to the latency satisfying the latency specification and the difference between the first heatmap and the second heatmap satisfying an accuracy specification.

18. The non-transitory computer readable medium according to claim 17, wherein the instructions are configured to cause the processor to receive a red-green-blue (RGB) image as the input image.

19. The non-transitory computer readable medium according to claim 17, wherein the instructions are configured to cause the processor to perform the object detection comprises using the in-vehicle NN model having fewer neurons than the trained NN.

20. The non-transitory computer readable medium according to claim 17, wherein the instructions are configured to cause the processor to cause an in-vehicle model training system to wirelessly transmit the in-vehicle NN model to a vehicle.
